(19) United States
(12) Patent Application Publication
(10) Pub. No.: US 2026/0119584 A1
(43) Pub. Date: Apr. 30, 2026

(54) Identifying Domains for Priority Rendering at User Interface Output Devices

(71) Applicant: Google LLC, Mountain View, CA (US)

(72) Inventors: Qian Zhong, Mountain View, CA (US); Xi Chen, Sunnyvale, CA (US); Chensheng Kuang, Bellevue, WA (US); Rui Chen, Mountain View, CA (US)

(21) Appl. No.: 18/933,897

(22) Filed: Oct. 31, 2024

(51) Int. Cl. G06F 16/9038; G06F 40/30

(52) U.S. Cl. CPC G06F 16/9038; G06F 40/30

(57) ABSTRACT

A method implemented by one or more processors comprises identifying, from data stored in at least one memory, a plurality of prior search queries received by a computing system over a particular prior time period. The method further comprises determining, for each of the prior search queries, from a plurality of search query categories, a search query category associated with the prior search query. The method further comprises identifying a subset of the prior search queries based at least in part on stored user interactions with first prior search results returned, by the computing system, in response to receipt of the subset of prior search queries over the particular prior time period. The method further comprises identifying one or more domains of second prior search results returned, by the computing system, in response to receipt of the subset of prior search queries over the particular prior time period.

### BACKGROUND

Computing systems which identify information on the internet in response to a query and present relevant results via a user interface are typically referred to as search engines. Such systems may operate by crawling the web, indexing content, and returning multiple results based on a search query input to the system by a user. Selection of one or more of the returned results, for example by a user input, generally causes content from the selected result to be rendered via the user interface. This typically involves rendering of one or more web pages, or content from such web pages, at the user interface.

Having submitted a search query, users may select more than one of the returned results so as to cause rendering of corresponding web page content. For example, a user may initially choose and select a result which is prominently displayed at the user interface and then, following rendering of web page content from the initially selected result, return to a list of the multiple results presented at the user interface to choose and select a second result. The user may then return to the list of results to choose and select a third result, and so on.

As users select multiple results in this manner, user devices receive multiple user inputs, for example via a touchscreen or another user input device. The inputs are processed by the user device to set in chain a series of other operations which ultimately cause web page content corresponding to the selected result to be rendered to the user. For example, each rendering of web page content may involve processing of the user input, transmission and receipt of data over the internet to request and receive the relevant content from one or more different computing systems hosting web page content, processing and memory operations at one or more devices associated with the transmission and receipt of the data, and further processing and memory operations to render the content via a user interface device. There are also power demands associated with the computing and communications hardware used to implement these operations.

As individual users move through selection of multiple search results in the manner outlined above, corresponding usage of computing and power resources increases. In view of the large volume of individuals who may be using a popular search engine during any given time period, changes to the average number of search results selected by users from lists of multiple results rendered in response to a single query can significantly impact the total computing and power resource consumption caused by use of the search engine over the period. If the average number of results selected by users per search query were reduced, fewer computing and power resources would be required.

### SUMMARY

Implementations described herein relate to identifying domains from which to prioritize rendering of web-based search results. As explained herein, the implementations may involve determining how users interacted with particular ones of prior rendered search results and determining categories of prior search queries which are particularly associated with a certain type of user interaction, such as selection of a particular type of search result. The domains of prior search results rendered in response to particular categories of prior search queries can be identified as domains which should be prioritized when selecting search results to render in response to future search queries in those categories.

In accordance with implementations described herein, domains identified in this manner may be rich in specialized content suitable for responding to search queries in the particular categories. Priority rendering of search results from these domains may produce a reduction in the number of individual search results selected by users when multiple search results are rendered in response to a search query submitted to a computing system operating a search engine. This is because such priority rendering may direct users to select search results from the identified domains in the first instance, and in doing so cause highly relevant web content from the domains to be rendered to the user.

The high relevance of the rendered content to the user's search query decreases the likelihood of the user subsequently selecting another search result from the initially rendered multiple search results. This is because the user has been provided with content, from one of the aforementioned domains, so as to fully satisfy their query.

In these respects, implementations described herein may be associated with various technical effects. These technical effects include reduced usage of processing, memory and power resources at various computers involved in requesting and providing content over the internet for rendering to users following selection of search results. This is at least in part because fewer selections of individual search results leads directly to corresponding reductions in data traffic between computers hosting web pages associated with the search results and user devices at which content from a web page is rendered following user selection of a search result. The technical effects also include corresponding reductions in processing, memory and power resources at the user devices. This is at least in part due to the user devices receiving fewer user inputs associated with making selections of different rendered search results, and implementing fewer processing/memory operations associated with rendering web content from different sources. The technical effects also extend to reduced use of communication resources between the computers hosting the aforementioned web pages and the user devices, since each selection of a search result at a user device may prompt exchanges of data traffic over the internet between the user device and the computers hosting web content associated with the initially rendered search results.

In implementations described herein, prioritized rendering of web-based search results may involve emphasizing and/or otherwise prominently rendering the search results via a user interface device.

Responding to a particular category of search query by emphasizing or otherwise prominently rendering search results from domains which are rich in specialized content suitable for satisfying the particular category of search query can be associated with the various technical benefits outlined above. For example, when a search result from such domains is emphasized or otherwise prominently rendered in response to a search query in the particular category of query, there is a significantly increased likelihood of a user choosing the search result as their first selection when multiple other results responsive to the query are also simultaneously rendered at a user interface. Due to the specialized nature of the web page content then rendered at the user interface, the likelihood of the user subsequently choosing to select another result from the multiple other results in order to have alternative content rendered at the user interface is reduced.

A reduction in the total number of search results selected by a user leads to a corresponding reduction in the usage of technical resources involved in providing and rendering web page content to users. For example, as outlined above, processing of user inputs to a user interface device, transmission and receipt of data over the internet to request, send and receive web page content from different host computers, and processing and memory operations to render the content via the user interface device, are all reduced. This is because such operations are generally carried out for each separate user selection of a search result rendered in response to a search query. Power demands associated with the use of computing hardware to implement these operations are also reduced.

When these effects are multiplied across large numbers of users who are all submitting search queries and selecting rendered search results within a given time period (e.g., one hour, day or week), the magnitude of the computing and power resource reductions outlined above may be significant.

Selecting the domains from which to prominently render particular search results, in favour of other possible results from other domains, can involve processing of historical data to determine that content available at the domain is rich and specialized to one or more particular categories of search query. The historical data can indicate which domains have provided prior search results in high concentrations in response to particular categories of prior search query, indicating that the content accessible at the domain is both relevant and specialized to the category of query.

For example, implementations described herein involve leveraging stored data concerning prior queries submitted by users to a computing system. The stored data may evidence that prior search results from one or more particular domains have been returned by the computing system at a high volume and/or frequency in response to prior search queries in a particular search query category. The historical data may also show that prior search results from these same domains have been returned at a significantly lower volume and/or frequency in response to prior search queries which were not in that particular search query category. This may be an indication that the domains are associated with web page content which is highly specialized to the particular category of search query while being significantly less specialized to other categories of search query.

Alternatively expressed, the historical data may show that, for a given prior time period, search results from particular domains were highly concentrated in responses by the computing system to one or more specific categories of search query, while at the same time being returned frequently and/or in relatively high numbers. The historical data may also show that, for the same given prior time period, search results from the particular domains were relatively infrequent and returned in low numbers in responses by the computing system to other specific categories of search query.

As an illustrative example, domains which are rich and specialized in a particular modality of content, such as images or video suitable for satisfying a particular category of search query submitted to a computing system operating a search engine may be determined from historical data in order to identify domains to prioritize when selecting search results to return in response to future queries in the particular category. The historical data may be stored in memory and may describe or otherwise indicate how users interacted with or otherwise reacted to prior search results returned by the computing system. In this example, the prior search results were returned to users in response to search queries submitted to the computing system over a known period of time, such as one day, week or month. Specifically, in this example, the prior search results were returned by the computing system to a plurality of personal user devices associated with the users. Examples of such user devices include, but are not limited to, personal computers, tablet computers, and smartphones.

The user devices each included one or more output user interface devices for outputting content to their user. Examples include one or more display devices for displaying content in visual form, and/or one or more audio output devices, such as one or more speaker devices, for outputting content in audible form. The user devices each also included one or more input user interface devices for detecting user inputs. Examples include one or more touchscreens for detecting touch inputs, and/or one or more microphones for detecting speech or other sound inputs from the user of the device.

The output user interface devices were operable to render the prior search results and related web content caused by user selection of the prior search results. The input user interface devices were operable to detect user interactions with the prior search results and any further web content caused to be rendered by user selection of the prior search results.

In this example, the historical data concerning how users interacted with the prior search results returned by the computing system operating the search engine over the given, known time period was generated by monitoring user inputs to the user devices, as detected by the one or more input user interface devices. For example, user interaction data may have been generated at each user device and transmitted to a centralized computing apparatus such as a server system where it was stored in the one or more memories for later access by the computing system operating the search engine. Other implementations of the one or more memories and/or the generation of the data are equally possible. For example, instead of the data being generated at the user devices, the user devices may have transmitted indications of the user interactions to the centralized computing apparatus so as to facilitate generation of the data at the centralized computing apparatus. The centralized computing apparatus may be part of the computing system operating the search engine, or may be separate from but communicatively coupled to the computing system operating the search engine.

The stored historical data may be used to identify a plurality of prior search queries submitted to the computing system operating the search engine by users during the known time period mentioned above. As previously highlighted, the total number of these search queries may be large if many users are submitting queries, via their user devices, to the computing system during the time period.

In implementations described herein, as part of analysing the historical data, a search query category of each of the prior search queries indicated by the historical data may be determined by one or more computer processors. In particular, the one or more processors may determine that the respective prior search queries indicated by the historical data are associated with various different search query categories.

A context to this determination process is that a total search query space in which the search computing system operates to return search results is represented by a large number of search query categories. The search query categories are separated from each other by partitions in the total query space. Each possible search query that can be formulated by a user and submitted to the computing system via a user device is associated with a search query category in the total query space. Multiple search queries which are all associated with the same search query category represent a query cluster in the total query space. As an illustrative example, there may be approximately 23 million search query categories across the total search query space.

Having determined the search query categories associated with the various prior search queries in the stored data, the one or more processors responsible for determining domains to be prioritized when rendering future search results move on to identify ones of these search query categories which are linked to a particular type of user intent. An example of such a user intent may be a wish or propensity for users to view non-text content, such as images or video, when submitting search queries to the computing system.

The computing system achieves this by assessing, from the stored historical data, stored user interactions with search results returned by the computing system in response to each of the prior search queries. Specifically, the computing system determines user interactions with prior search results which are representative of users demonstrating the particular type of user intent. For example, where the particular type of user intent is a propensity to seek out and view image content, the computing system identifies all user interactions with prior search results which led to a new rendering of image content at the user device. These interactions could, for instance, involve the selection by a user of a reduced-size image (e.g., a thumbnail) initially rendered as part of a group of prior search results, where the selection of the reduced-size image caused a new rendering of a full-size version of the image.

When such a user interaction is identified, the one or more processors determine and store the prior search query which led to the search computing system returning the relevant prior search result. The one or more processors may also store the search query category associated with the prior search query. These prior search queries and associated search query categories may be stored in memory as a distinct subset of the total prior search queries indicated by the historical data as having been received by the search computing system during the known period of time mentioned previously.

Once all stored user interactions representative of users demonstrating the particular type of user intent have been identified, and the corresponding prior search queries discussed above have been stored as a subset of the total prior search queries, the computing system may sort the plurality of search query categories associated with the prior search queries into an order. This may involve ranking the plurality of search query categories according to a total fraction of prior search queries, associated with each search query category, that led to a user interaction representative of the particular type of user intent.

For example, where the particular type of user intent is a propensity to seek out and view image content, the computing system may determine the search query categories which are associated with the prior search queries that ultimately led to new renderings of image content due to user interactions with search results returned responsive to the prior search queries. The search query categories may then be ranked according to the total fraction of prior search queries in each category that led to a user interaction representative of users seeking out and viewing image content.

The ranking process, when employed, may be used reduce the number of search query categories to be considered by the one or more processors as part of further identifying domains to be prioritized when selecting search results for rendering in response to future queries. For example, to reduce the total number of search query categories and therefore the amount of processing resource required for the domain identification process going forward, a threshold may be applied to the total fraction of prior search queries, associated with each search query category, that led to a user interaction representative of the particular type of user intent. The search query categories determined to have fractions higher than a set threshold fraction may continue to be considered as part of identifying domains to be prioritized when selecting future search results for rendering to users, whereas search query categories determined to have fractions lower than the threshold fraction may be dismissed from the process. The threshold fraction may be expressed as a decimal number, such as 0.28.

The threshold fraction may be chosen so as to carry forward in the process a particular percentage of search query categories from the total search query space. For example, the threshold fraction may be chosen so as to carry forward approximately 10% of search query categories from the total search query space. This may equate to approximately 10% of search queries from the total search query space and, for example, approximately 50% of the stored user interactions representative of the particular type of user intent.

Whether or not a ranking and a subsequent threshold-based reduction of the number of search query categories is carried out, it will be appreciated that those search query categories with the highest value fractions are the search query categories which are most associated with stored user interactions representative of the particular type of user intent. Put another way, the search query categories with the highest value fractions are the search query categories which are most associated with users exhibiting behaviour matching the particular type of user intent when presented with rendered search results.

Reverting again to the example of the particular user intent being a propensity to seek out and view image content, the search query categories with the highest fractions are those which are associated with high numbers of prior search queries that led, according to the historical data, to a user interactions representative of users seeking out and viewing image content.

In a next stage, the one or more processors progress to determining, from the stored historical data and for the stored subset of prior search queries (which may have been further reduced in number according to the threshold-based filtering process discussed above), a set of prior search results returned by the search computing system during the known time period. For example, all prior search results which were returned in response to each prior search query in the subset of prior search queries may be determined and collated by the one or more processors. Alternatively, a smaller proportion of prior search results returned in response to each prior search query in the subset of prior search queries may be determined and collated. Where a smaller proportion is determined, the proportion may correspond to the ‘first page’ search results returned in response to each prior search query in the subset of prior search queries. Alternatively, the proportion may correspond to a number of top ranked ones of the prior search results (e.g., the top ten results) according to the rendering of the prior search results during the known time period.

To distinguish between these collated prior search results and the individual prior search results with which users were recorded to have interacted to cause the stored interactions representative of the user exhibiting the particular type of user intent, the collated prior search results may be referred to herein as second prior search results whereas the individual prior search results with which users were recorded to have interacted may be referred to herein as first prior search results.

The one or more processors may then identify, from the stored historical data, all of the domains corresponding to the collated second prior search results and generate a score for each domain. The score for each of the identified domains is indicative of the degree to which the domain should be prioritized when selecting search results for rendering in response to future search queries submitted to the search computing system by users.

Generating the score for each domain may involve consideration of at least two parameters indicated in the stored historical data. A first of these parameters is the total number of times prior search results from the domain appear in the collated group of second prior search results described above. That is, the first parameter may be the total number of times prior search results from the domain appear in results which were returned during the known time period in response to the subset of prior search queries mentioned previously. The first parameter represents the magnitude of second prior search results which are from the domain. In particular, the first parameter represents the volume and average frequency at which search results from the domain were returned during the known period.

A second of the parameters used in generating the score for each domain is the total number of search query categories associated with prior search queries in the subset of prior search queries which, when submitted to the search computing system during the known time period, caused the search computing system to return search results from the domain. This may be referred to as the total number of search query categories with which the domain co-triggers. The second parameter represents the spread of search results from the domain across different search query categories in the total search space. It may be expressed as the correspondence between the domain and the search query categories associated with the subset (or threshold-reduced subset) of prior search queries.

If the web content at the domain is diverse in nature, for example by relating to many different subject-matter areas, the total number of search query categories with which the domain co-triggers is likely to be relatively high. This is because different search query categories may be considered to represent regions of the total search space which are linked to different kinds of subject-matter area.

On the other hand, if web content at the domain is not diverse in nature, for example because it relates primarily to a particular subject-matter area, the total number of search query categories with which the domain co-triggers is likely to be relatively low.

For example, a domain at which web content primarily concerns a specialized subject-matter area such as computer repair, is likely to co-trigger across relatively few search query categories. At the other end of the spectrum, a domain at which web content relates to a wide variety of encyclopaedia entries across many different diverse subject areas will likely co-trigger across a large number of search query categories in the total search space.

The generated score for each domain may be directly related to a product of (i) a representation of the first parameter and (ii) an inverse representation of the second parameter. For example, the score for each domain may be generated as being directly proportional to a product of a representation of the first parameter and a log of an inverse representation of the second parameter. The following equation may be used,

$$TF - IDF = TF * Log ( c / DF )$$

where TF-IDF represents the score for the domain, TF represents the first parameter for the domain, and DF represents the second parameter for the domain. c may represent a constant such as the total number of all search query categories in the search space. Alternatively, c may represent the total number of the subset of prior search queries. The score, TF-IDF, may be referred to as the ‘term frequency-inverse document frequency’ for the domain.

The one or more processors use the scores generated for each domain of the second prior search results to identify one or more domains from which to prioritize rendering of further search results at a user interface device in response to receipt by the search computing system of a further search query. Generating the score in the manner described above, using the first and second parameters, may have the effect of significantly down weighting domains at which a large amount of content is diversely spread across many subject-matter areas. This makes those domains relatively less likely to score well and, in turn, relatively less likely to be identified for prioritized rendering of search results in response to future search queries in particular categories. This may be advantageous for the technical effects outlined above because web page content at these large but diversely spread domains may be less specialized to particular search query categories than domains at which content is concentrated in specific subject-matter areas, such as the domain primarily concerned with computer repair tasks mentioned previously.

The one or more processors may identify domains from which to prioritize rendering of future search results by applying a threshold to the scores generated for the domains of the second prior search results. For example, a score threshold may be used as part of a filter process to identify the ten thousand domains (or other predetermined number) with the highest scores. The domains remaining following the filter process may cover approximately 80% of the aforementioned stored user interactions for search query categories corresponding to the domains.

For example, when the user intent is a propensity to seek out and view image content and the stored user interactions represent interactions by users with first prior search results associated with image content, the remaining domains following the filter process may cover approximately 80% of the stored user interactions for the search query categories corresponding to the remaining domains.

In other words, the remaining domains are rich and specialized in image content for their corresponding search query categories.

Following the identification of domains from which to prioritize rendering of future search results in response to search queries in various categories, as discussed above, a further search query associated with a particular search query category may be received by the search computing system. When the particular search query category of the newly-received search query matches one of the search query categories associated with the subset of prior search queries in the stored historical data, the search computing system may respond by prioritizing rendering of one or more search results from the identified domains discussed above. In particular, the search computing system may prioritize rendering of one or more search results from one or more of the domains which were determined, from the historical data, to have correspondence with the particular search query category.

Returning again to the example where stored user interactions with first prior search results which were rendered in response to a particular category of prior search query are representative of users being interested in image content, prioritized rendering of search results from domains which have a concentrated correspondence to the particular search query category associated with the newly-received search query and are also rich in image content will (i) increase the likelihood of the user selecting a search result from the prioritized domain and (ii) increase the likelihood of the user being satisfied by the web content rendered in response to selection of the search result.

For the purposes of illustration, if the particular search query category associated with the newly-received search query relates to computer repair, and the stored user interactions for prior search queries in that category show that users who submit queries relating to computer repair are intent on viewing image content, prioritizing domains in the manner explained above has a high likelihood of search results for images of computer repair being prominently rendered to the user.

The prominent rendering of such results may involve causing the search results to be rendered with increased visual emphasis relative to one or more other rendered search results displayed alongside them at a display screen of the user device. Additionally or alternatively, the prominent rendering of such results may involve causing the search results to be rendered at a content-modality-specific portion of a user interface displayed at the display screen. For image content, the content-modality-specific portion may be an image-specific portion of the user interface.

While for the purposes of illustration the user intents discussed above have been mentioned in the context of users being interested in image content, the user intents may alternatively relate to other types of content such as video content, audio content, commercial content or sponsored content. For video content, the content-modality-specific portion may be a video-specific portion of the user interface. For audio content, the content-modality-specific portion may be a video-specific portion of the user interface. For commerce content, the content-modality-specific portion may be a commerce-specific portion of the user interface. For sponsored content, the content-modality-specific portion may be a commerce-specific portion of the user interface.

Each of the content-modality-specific portions of the user interface may be accessible via one or more dedicated, labelled and selectable tabs or other visual markers in the user interface. By selecting the tabs to view content-modality specific search results returned by the search computing system responsive to a search query, the user is presented with prominently rendered search results from domains which are specialized to their search query.

Implementations described herein provide a method implemented by one or more processors, the method comprising: identifying, from data stored in at least one memory, a plurality of prior search queries received by a computing system over a particular prior time period; determining, for each of the prior search queries, from a plurality of search query categories, a search query category associated with the prior search query; identifying a subset of the prior search queries based at least in part on stored user interactions with first prior search results returned, by the computing system, in response to receipt of the subset of prior search queries over the particular prior time period; identifying one or more domains of second prior search results returned, by the computing system, in response to receipt of the subset of prior search queries over the particular prior time period; determining a correspondence between each of the one or more domains and search query categories associated with the subset of prior search queries; generating, for each of the one or more domains, a score based at least in part on (i) a magnitude of the second prior search results from the domain and (ii) the correspondence between the domain and the search query categories associated with the subset of prior search queries; and identifying, from the one more domains, based at least in part on the score for each of the one or more domains, at least one domain from which to prioritize rendering of further search results at a user interface device in response to receipt by the computing system of a further search query.

The stored user interactions with the first prior search results may be representative of particular user intents associated with the subset of prior search queries.

The method may further comprise, in response to receipt by the computing system of the further search query, causing at least one further search result from the identified at least one domain to be rendered at the user interface device. The further search query may be associated with a particular search query category and the identified at least one domain may have correspondence with the particular search query. The first prior search results and the at least one further search result may each be associated with a content modality other than text. As examples, the content modality may be any of image content, video content, audio content, commerce content and sponsored content.

Causing the at least one further search result to be rendered at the user interface device may comprise causing the at least one further search result to be rendered with increased visual emphasis relative to one or more other rendered search results displayed alongside the at least one further search result at a display screen of the user interface device. Additionally or alternatively, causing the at least one further search result to be rendered at the user interface device may comprise causing the at least one further search result to be rendered in a content-modality-specific portion of a user interface displayed at a display screen of the user interface device. The at least one further search result may be associated with image content and the content-modality-specific portion of the user interface may be a portion of the user interface specific to search results associated with image content. Alternatively, the at least one further search result may be associated with video content and the content-modality-specific portion of the user interface may be a portion of the user interface specific to search results associated with video content. Other examples are possible, as mentioned previously.

When the first prior search results are associated with image content, video content, audio content, sponsored content, commerce content, or another specific modality, causing the at least one further search result to be rendered at the user interface device may comprise causing the at least one further search result to be rendered respectively as image content, video content, audio content, sponsored content, commerce content, or another content in accordance with the other specific modality.

The first prior search results, the second prior search results and the at least one further search result may each be indicative of web page content.

Determining the correspondence between each of the one or more domains and search query categories associated with the subset of prior search queries may comprise, for each prior search query in the subset of prior search queries, identifying the one or more domains as including domains of search results returned by the computing system in response to receipt of the prior search query; and determining, for each of the domains of search results returned by the computing system in response to receipt of the prior search query, a correspondence between the domain and the search query category associated with the prior search query.

Generating a score for each of the one or more domains may comprise, for each prior search query in the subset of prior search queries, generating, for each of the domains of search results returned by the computing system in response to receipt of the prior search query, the score based at least in part on the determined correspondence between the domain and the one or more search query categories associated with the prior search query.

For example, generating a score for each of the one or more domains may comprise multiplying: (i) a representation of the magnitude of second prior search results from the domain, by (ii) an inverse representation of a magnitude of the search query categories corresponding to the domain.

Implementations described herein also provide a method implemented by one or more processors, the method comprising: identifying, from data stored in memory concerning search queries received by a computing system over a particular prior time period, a plurality of search queries; determining, from the data stored in memory, a subset of the identified plurality of search queries based on stored user interactions associated with the subset of search queries over the particular prior time period, wherein the stored user interactions are indicative of a particular user intent associated with the subset of search queries; and determining one or more search query categories corresponding to the subset of search queries.

The method additionally comprises, for each search query in the subset of search queries: identifying a plurality of search results returned in response to the search query over the particular prior time period; identifying one or more domains corresponding to the identified plurality of search results; and determining a correspondence between each of the identified one or more domains and the determined one or more search query categories.

The method additionally comprises scoring the one or more domains based at least in part on a representation of a sum of the pluralities of search results corresponding to each domain and the determined correspondence between each domain and the one or more search query categories; and determining, based on the scoring, at least one domain of the one or more domains from which to prioritize rendering of search results at a user interface device in response to a further search query in a search query category corresponding to the at least one domain.

The method may further comprise, in response to receipt by the computing system of the further search query, causing at least one further search result from the determined at least one domain to be rendered at the user interface device. Causing the at least one further search result to be rendered at the user interface device may comprise causing the at least one further search result to be rendered in a prominent region of a user interface displayed at a display screen of the user interface device.

Implementations described herein also provide a system comprising: one or more processors; and at least one memory storing instructions which, when executed by the one or more processors, cause the one or more processors to: identify a plurality of prior search queries received by a computing system over a particular prior time period; determine, for each of the prior search queries, from a plurality of search query categories, a search query category associated with the prior search query; identify a subset of the prior search queries based at least in part on stored user interactions with first prior search results returned, by the computing system, in response to receipt of the subset of prior search queries over the particular prior time period; identify one or more domains of second prior search results returned, by the computing system, in response to receipt of the subset of prior search queries over the particular prior time period; determine a correspondence between each of the one or more domains and search query categories associated with the subset of prior search queries; generate, for each of the one or more domains, a score based at least in part on (i) a magnitude of the second prior search results from the domain and (ii) the correspondence between the domain and the search query categories associated with the subset of prior search queries; and identify, from the one more domains, based at least in part on the score for each of the one or more domains, at least one domain from which to prioritize rendering of further search results at a user interface device in response to receipt by the computing system of a further search query.

Implementations described herein also provide a non-transitory computer-readable storage medium storing instructions which, when executed by one or more processors, cause the one or more processors to: identify a plurality of prior search queries received by a computing system over a particular prior time period; determine, for each of the prior search queries, from a plurality of search query categories, a search query category associated with the prior search query; identify a subset of the prior search queries based at least in part on stored user interactions with first prior search results returned, by the computing system, in response to receipt of the subset of prior search queries over the particular prior time period; identify one or more domains of second prior search results returned, by the computing system, in response to receipt of the subset of prior search queries over the particular prior time period; determine a correspondence between each of the one or more domains and search query categories associated with the subset of prior search queries; generate, for each of the one or more domains, a score based at least in part on (i) a magnitude of the second prior search results from the domain and (ii) the correspondence between the domain and the search query categories associated with the subset of prior search queries; and identify, from the one more domains, based at least in part on the score for each of the one or more domains, at least one domain from which to prioritize rendering of further search results at a user interface device in response to receipt by the computing system of a further search query.

Implementations described herein also provide computer-readable instructions which, when executed by one or more processors, cause the one or more processors to: identify a plurality of prior search queries received by a computing system over a particular prior time period; determine, for each of the prior search queries, from a plurality of search query categories, a search query category associated with the prior search query; identify a subset of the prior search queries based at least in part on stored user interactions with first prior search results returned, by the computing system, in response to receipt of the subset of prior search queries over the particular prior time period; identify one or more domains of second prior search results returned, by the computing system, in response to receipt of the subset of prior search queries over the particular prior time period; determine a correspondence between each of the one or more domains and search query categories associated with the subset of prior search queries; generate, for each of the one or more domains, a score based at least in part on (i) a magnitude of the second prior search results from the domain and (ii) the correspondence between the domain and the search query categories associated with the subset of prior search queries; and identify, from the one more domains, based at least in part on the score for each of the one or more domains, at least one domain from which to prioritize rendering of further search results at a user interface device in response to receipt by the computing system of a further search query.

Implementations described herein also provide a system comprising: one or more processors; and at least one memory storing instructions which, when executed by the one or more processors, cause the one or more processors to perform operations comprising: identifying, from data stored in memory concerning search queries received by a computing system over a particular prior time period, a plurality of search queries; determining, from the data stored in memory, a subset of the identified plurality of search queries based on stored user interactions associated with the subset of search queries over the particular prior time period, wherein the stored user interactions are indicative of a particular user intent associated with the subset of search queries; and determining one or more search query categories corresponding to the subset of search queries. The operations additionally comprise, for each search query in the subset of search queries: identifying a plurality of search results returned in response to the search query over the particular prior time period; identifying one or more domains corresponding to the identified plurality of search results; and determining a correspondence between each of the identified one or more domains and the determined one or more search query categories. The operations additionally comprise scoring the one or more domains based at least in part on a representation of a sum of the pluralities of search results corresponding to each domain and the determined correspondence between each domain and the one or more search query categories; and determining, based on the scoring, at least one domain of the one or more domains from which to prioritize rendering of search results at a user interface device in response to a further search query in a search query category corresponding to the at least one domain.

Implementations described herein also provide a non-transitory computer-readable storage medium storing instructions which, when executed by one or more processors, cause the one or more processors to perform operations comprising: identifying, from data stored in memory concerning search queries received by a computing system over a particular prior time period, a plurality of search queries; determining, from the data stored in memory, a subset of the identified plurality of search queries based on stored user interactions associated with the subset of search queries over the particular prior time period, wherein the stored user interactions are indicative of a particular user intent associated with the subset of search queries; and determining one or more search query categories corresponding to the subset of search queries. The operations additionally comprise, for each search query in the subset of search queries: identifying a plurality of search results returned in response to the search query over the particular prior time period; identifying one or more domains corresponding to the identified plurality of search results; and determining a correspondence between each of the identified one or more domains and the determined one or more search query categories. The operations additionally comprise scoring the one or more domains based at least in part on a representation of a sum of the pluralities of search results corresponding to each domain and the determined correspondence between each domain and the one or more search query categories; and determining, based on the scoring, at least one domain of the one or more domains from which to prioritize rendering of search results at a user interface device in response to a further search query in a search query category corresponding to the at least one domain.

Implementations described herein also provide computer-readable instructions which, when executed by one or more processors, cause the one or more processors to perform operations comprising: identifying, from data stored in memory concerning search queries received by a computing system over a particular prior time period, a plurality of search queries; determining, from the data stored in memory, a subset of the identified plurality of search queries based on stored user interactions associated with the subset of search queries over the particular prior time period, wherein the stored user interactions are indicative of a particular user intent associated with the subset of search queries; and determining one or more search query categories corresponding to the subset of search queries. The operations additionally comprise, for each search query in the subset of search queries: identifying a plurality of search results returned in response to the search query over the particular prior time period; identifying one or more domains corresponding to the identified plurality of search results; and determining a correspondence between each of the identified one or more domains and the determined one or more search query categories. The operations additionally comprise scoring the one or more domains based at least in part on a representation of a sum of the pluralities of search results corresponding to each domain and the determined correspondence between each domain and the one or more search query categories; and determining, based on the scoring, at least one domain of the one or more domains from which to prioritize rendering of search results at a user interface device in response to a further search query in a search query category corresponding to the at least one domain.

The above description is provided as an overview of some implementations of the present disclosure. Further description of those implementations, and other implementations, are described in more detail below with reference to the accompanying figures.

### BRIEF DESCRIPTION OF THE FIGURES

FIG. 1 is a diagram of an example environment 100 comprising client devices, search computing system(s) and web server computing apparatuses communicatively coupled by one or more communication networks.

FIG. 2 is a flowchart illustrating an example method of identifying at least one domain from which to prioritize rendering of search results at an output user interface device of a client device in response to receipt by search computing system(s) of a search query.

FIG. 3 is a flowchart illustrating an example method of determining at least one domain from which to prioritize rendering of search results at an output user interface device in response to a search query in a search query category corresponding to the at least one domain.

FIG. 4 is a schematic diagram of a computing apparatus for implementing techniques described herein.

### DETAILED DESCRIPTION

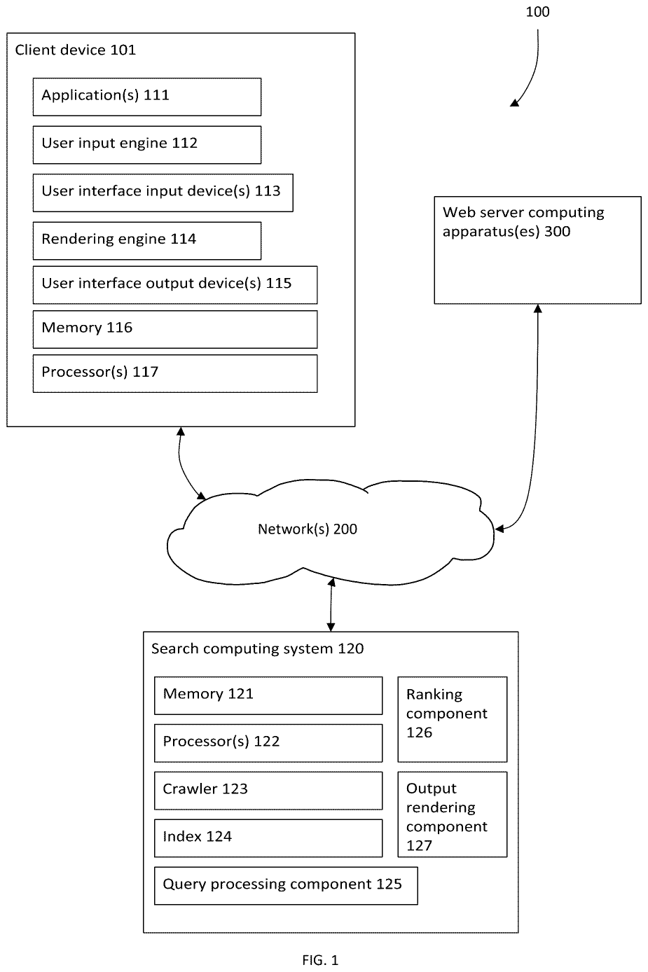

FIG. 1 is a block diagram of an example environment 100 that is illustrative of aspects of the present disclosure. Implementations disclosed herein can be carried out in the depicted environment. The environment 100 includes a client device 110 and search computing system(s) 120.

The client device 110 can be, for example, a personal user device such as a smart phone, a tablet, a desktop computer or a laptop computer. Other types of personal user device are equally possible, including other smart devices such as interactive speaker devices with displays and wearable devices such as smart watches. The client device 110 can execute one or more applications 111 via which search queries can be submitted and response(s) to the search query can be rendered. Responses to the search query may be in the form of individual search results provided by the search system(s) 120. Additionally or alternatively, responses(s) to the search query may be in the form of natural language-based summaries generated by the search system(s) 120 or, alternatively, at client device 110. The application(s) 111 may be separate from an operating system of the client device 110.

The client device 110 can include user input engine 112 configured to detect user inputs to the client device 110 using one or more user interface input devices 113 of the client device 110. For example, user interface input devices 113 of the client device 110 may include one or more touch sensitive components such as a keyboard, a mouse, a touch screen, a touch panel and/or one or more hardware buttons. User interface input devices 113 of the client device 110 may also include one or more microphones that capture audio data, such as audio data corresponding to speech of the user directed toward the client device 110. Other types of user interface input device 113 are equally possible. The user interface input devices 113 may operate in tandem with the user input engine 112 to facilitate user inputs to the client device 110 in the form of search queries and/or selections of rendered search results, among other types of input.

The client device 110 may also include rendering engine 114 configured to render search results and other forms of content, such as natural language-based summaries, to a user of the client device 110 using one or more user interface output 115 devices of the client device 110. User interface output devices 115 of the client device 110 may include one or more speakers for audible rendering of content and/or one or more displays for visual rendering of content.

The client device 110 may further include one or more memories 116 for storage of data and/or software applications, one or more processors 117 for accessing data and executing the software applications, and/or other components that facilitate communication over one or more of networks 200 with the search system(s) 120 and other remote computing apparatuses. The software applications can be installed locally at the client device 110 or may be hosted remotely at one or more remote servers accessible by the client device 110 over the network(s) 200. The network(s) 200 may comprise one or more wired or wireless local area networks (“LANs,” including Wi-Fi LANs, mesh networks, Bluetooth, near-field communication, etc.) or wide area networks (“WANs”, including the internet).

FIG. 1 has been generally described with respect to a single client device having a single user. However, one or more additional client devices of the user and/or of additional user(s) can also implement the techniques described herein. For example, the client device 110 and the one or more additional client devices can form an ecosystem of devices that operate together to perform the methods described herein. When involved, these additional client devices are communicatively coupled to the client device 110, for example via the one or more networks 200.

The search computing system(s) 120 comprises one or more computing apparatuses operable to receive search queries from the client device 110 over the communication network(s) 200 and return, via the communication networks(s) 200, one or more search results and/or natural language-based summaries representative of web page content for rendering at user interface output devices 115 of the client device 110. The search computing system(s) 120 includes one or more memories 121 for storage of data and/or software applications, one or more processors 122 for accessing data and executing the software applications, and/or other components that facilitate communication over the one or more of networks 200 with the client device 110 and other computing apparatuses.

The search computing system(s) 120 comprises a search engine. As will be understood by the skilled person, the search engine comprises a crawler component 123 which is operable to systematically explore the internet, index web pages and gather information about their content. The search engine also comprises an index database component 124 which is operable to store information about the crawled web pages, including keywords, metadata, and links. The search engine also comprises a query processing component 125 which is operable to receive search queries from user devices such as the client device 110, analyse the search queries, and transform them into a format suitable for searching the index database 124.

The search engine also comprises a ranking component 126 which is operable to determine the relevance of search results to a received search query. The ranking component 126 may determine relevance of various potential responses to a particular search query based on various factors such as keyword frequency, link popularity, and content quality. The search engine may also comprise an output rendering component 127, which may be responsible for the manner in which search results determined as being responsive to a search query are rendered, visually or audibly, at a user device such as the client device 110.

As discussed above, in this context, implementations described herein are operable to identify at least one domain from which to prioritize rendering of search results at an output user interface device of the client device 110 in response to receipt by the search computing system(s) 120 of a search query. The search query may be received from the client device 110 or, as discussed above, from one or more additional client devices. Alternatively, in implementations involving one or more additional client devices of this kind, the search results may be rendered at the one more additional devices responsive to receipt by the search computing system(s) 120 of a search query from the client device 110.

As further context to the previous and following disclosure, selection by a user of a search result for rendering at a user interface output device 115 of the client device 110 (or additional client device) may involve at least the following operations, or similar operations, which are intensive in terms of their consumption of computing and power resources at least at the client device 110, the communication network(s) 200, and one or more web server computing apparatuses 300 hosting web page content associated with the selected search result.

Firstly, a Domain Name System (DNS) lookup operation involves the sending of a request from the client device 110 to a DNS server apparatus to translate a domain name of the selected search result into an IP address. Secondly, the client device 110 establishes a connection over the communication network(s) 200 with one or more web server computing apparatuses (web server) at the IP address determined in the DNS lookup operation. Thirdly, the client device 110 sends an HTTP request over the communication network(s) 200 to the one or more web servers in order to request web page content associated with the selected search result. Fourthly, the one or more web servers send the requested web page content to the client device 110. Fifthly, the client device 110 processes the received web page content, such as HTML, CSS and/or JavaScript content, and causes rendering of the web page content to the user via one or more output user interface devices of the client device 110.

Implementations described herein may reduce the average number of rendered search results selected by a user. This can produce significant reductions in the consumption of computing and power resources at the client device 110, the communication network(s) 200, and at least the one or more web servers.

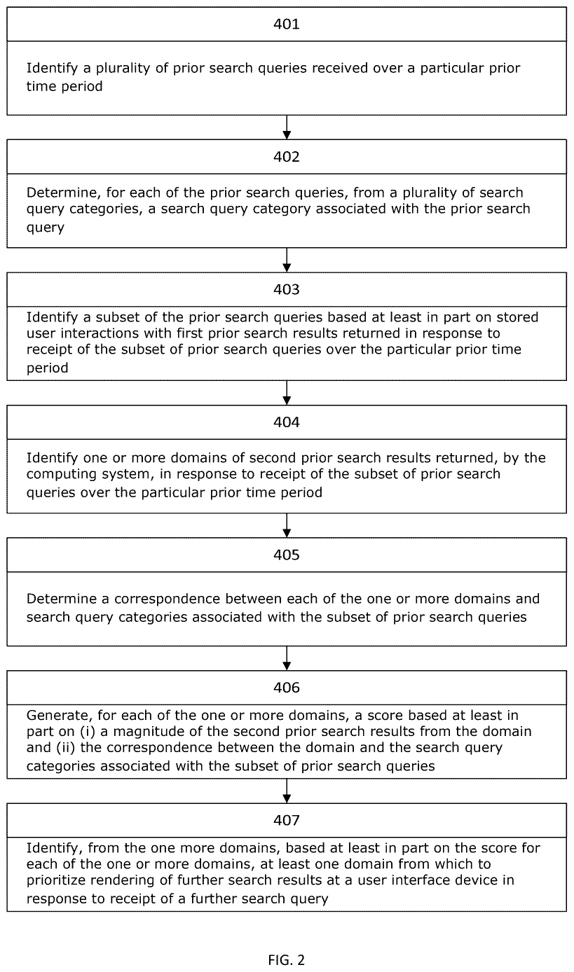

Example methods which may be performed using the hardware and infrastructure discussed above with respect to FIG. 1 will now be described, initially with respect to FIG. 2.

As discussed above, a total search query space across which a search computing system 120 operates to return search results may be represented by a large number of search query categories separated from each other by partitions in the total query space. The total query space may be referred to as Total Qspace, while the individual search query categories in the Total Qspace may be referred to as Qspaces. Each possible search query that can be formulated by a user and submitted to the search computing system 120 via a user device, such as client device 110, may be associated with a particular Qspace in the Total Qspace. Multiple search queries which are all associated with the Qspace represent a query cluster in the Total Qspace. As an illustrative example, there may be approximately 23 million Qspaces across the Total Qspace in which the search computing system 120 operates.

Each partitioned search query category, or Qspace, may represent search queries which are related by subject-matter area. For example, a first Qspace may represent search queries related to computer repair while a second, different Qspace may represent search queries related to vehicle repair. The large number of Qspaces within the Total Qspace allows for the subject-matter areas of Qspaces to be specialized within particular themes. For instance, a plurality of first N1 Qspaces may be related to computer repair tasks of different types, while a plurality of second N2 Qspaces may be related to vehicle repair tasks of different types, and so on.

Particular search query categories, or Qspaces, within the total query space, or Total Qspace, may be disproportionally associated with certain types of user interactions with the search results. These user interactions may be related to user intents and may be recorded in historical data about users' choices and selections made in response to rendering of pluralities of prior search results following historical search queries. For example, historical data indicative of search result selections made previously by large numbers of users may indicate that a first search query is particularly associated with a first type of user interaction, corresponding to a first user intent. The data may also indicate that second and third search query categories are particularly associated with, respectively, second and third types of user interaction with corresponding second and third user intents, and so on. An example of a type of user interaction is selection of search results of a particular modality, such as image results, video results, audio results, commerce results, or sponsored results.

The historical data may be stored in memory 121 of the search computing system 120 and may be leveraged to carry out the techniques described herein.

In a first operation 401 of the method 400 illustrated in FIG. 2, one or more processors identify, from data stored in at least one memory, a plurality of prior search queries received by a computing system over a particular prior time period. For example, the one or more processors 122 of the search computing system 120 may identify from historical data stored in memory 121 of the computing system 120 a total of all prior search queries (or a subset plurality of those prior queries) submitted to the search computing system 120 from user devices over a certain prior timeframe. The user devices may be client devices 110 communicatively coupled to the search computing system 120 by the communication network(s) 200 discussed above. The prior time period may be any prior period which is representative of a large number of users submitting search queries to the system 120.

In a second operation 402 of the method 400 illustrated in FIG. 2, the one or more processors determine, for each of the prior search queries, from a plurality of search query categories, a search query category associated with the prior search query. For example, the one or more processors 122 of the search computing system 120 may determine, from the stored historical data, a Qspace of each of the prior search queries (or a significantly sized subset of those queries) submitted to the search computing system 120 over the time period referred to above.

To give context to the second operation 402, the one or more processors 122 may determine, for example, that a first prior search query of “how do I remove the hard drive from my desktop computer” is of a first Qspace A related to computer maintenance, and that a second prior search query of “how do I connect my phone to my car's engine diagnostic system” is of a second Qspace B related to vehicle maintenance.

In a third operation 403 of the method 400 illustrated in FIG. 2, the one or more processors identify a subset of the prior search queries based at least in part on stored user interactions with first prior search results returned, by the computing system, in response to receipt of the subset of prior search queries over the particular prior time period. The stored user interactions with the first prior search results may be representative of particular user intents associated with the subset of prior search queries. For example, the one or more processors 122 of the search computing system 120 may identify all queries which, according to the historical data, led to selections of a particular first modality of search result from search results rendered to users. This may involve identifying all queries which led to selections of image results. Additionally or alternatively, this may involve identifying all queries which led to selections of video results. Additionally or alternatively, this may involve identifying all queries which led to selections of audio results. Additionally or alternatively, this may involve identifying all queries which led to selections of commerce results. Additionally or alternatively, this may involve identifying all queries which led to selections of sponsored results.

Selection by a user of a particular modality of search result may be indicative of a user intent associated with the search query. For example, selection of a video result may be indicative of a video intent associated with the query, selection of an image result may be indicative of an image intent associated with the query, selection of an audio result may be indicative of an audio intent associated with the query, and selection of a commerce result may be indicative of a commercial intent associated with the query. Selection of a sponsored result may also be indicative of a commercial intent associated with the query.

When the historical data indicates that there was a disproportionally high number of prior search queries, all from a particular search query category (i.e., a Qspace), that led to selection by users of a particular modality of search result, this is representative of the search query category (i.e., the Qspace) as a whole being associated with a corresponding user intent. A fraction may be used to assess this, such as the total number of selections the particular modality of search result divided by the total number of selections across all modalities of search result.

To give context, the one or more processors 122 may identify, for example, that prior search queries from Qspace A related to computer maintenance led to a high number users interacting with video-type search results. The one or more processors 122 may additionally or alternatively identify, for example, that prior search queries from Qspace B related to vehicle maintenance led to a high number users interacting with image-type search results. The one or more processors 122 may determine from this that Qspace A is associated with a video intent, and/or that Qspace B is associated with an image intent.

The one or more processors 122 may then rank all of the Qspaces associated with the prior search queries to identify Qspaces which are highly (e.g., disproportionally) associated with particular intents, such as an video intent or an image intent. Other intents are equally possible. For example, based on prior user interactions with audio-type search results, the one or more processors 122 may determine that Qspaces C (including search queries which led to user interactions with audio-type results) are associated with an audio intent. Additionally or alternatively, based on prior user interactions with commerce-type search results, the one or more processors 122 may determine that Qspaces D (including search queries which led to user interactions with commerce-type results) are associated with a commercial intent. Additionally or alternatively, based on prior user interactions with sponsored search results, the one or more processors 122 may determine that Qspaces E (including search queries which led to user interactions with sponsored results) are associated with a commercial intent.

Where ranking of Qspaces is deployed, the prior search queries which are most associated with particular user intents are taken forward in the process (e.g., as the subset of prior search queries referred to above). All other prior search queries may be dismissed at this stage, on the basis that they may be regarded as not strongly-enough associated with a particular user intent.

In a fourth operation 404 of the method 400 illustrated in FIG. 2, the one or more processors identify one or more domains of second prior search results returned, by the computing system, in response to receipt of the subset of prior search queries over the particular prior time period. For example, the one or more processors 122 of the search computing system 120 may identify from the stored historical data the domains of all search results returned by the search computing system 120 in response to search queries from the Qspaces identified in the third operation 403 described above. Alternatively, the one or more processors 122 of the search computing system 120 may identify the domains of a top-ranked portion of all search results returned by the search computing system 120 in response to search queries from the Qspaces identified in the third operation 403. For example, the one or more processors may identify the domains of search results which were returned by the search computing system 120 for rendering as ‘first page’ search results in response to the search queries. These search results may be the top n-ranked search results returned in response to the query, where n may be five, ten or another suitable number representative of search results which were rendered to users.

To continue the themes outlined above, and to provide additional context to the fourth operation 404, the one or more processors may, for example, identify the domains of all, or a subset, of search results which were returned in response to search queries in any of Qspaces A, B, C, D and/or E linked to particular user intents of, respectively, of video, image, audio, or commerce. These second prior search results may be inclusive of the first search results mentioned above with respect to the third operation 403, and may also include other search results returned alongside the first search results but not necessarily selected by users according to the historical data.

In a fifth operation 405 of the method 400 illustrated in FIG. 2, the one or more processors determine a correspondence between each of the one or more domains identified in the fourth operation 404 and search query categories associated with the subset of prior search queries identified in the third operation 403. For example, the one or more processors 122 of the search computing system 120 may identify, from the historical data, a first set of domains X of search results which were returned in response to search queries in Qspace A, a second set of domains Y of search results which were returned in response to search queries in Qspace B, a third set of domains Z of search results which were returned in response to search queries in Qspace C, and so on. In some instances, a domain may have correspondence with only a small number of Qspaces. In other instances, a domain may have correspondence with a much larger number of Qspaces.

For example, search results from a first domain D1 may have been returned in response to search queries in Qspace A only, whereas search results from a second domain D2 may have been returned in response to search queries in Qspaces A, B, C and D. As outlined above, since Qspaces A, B, C and D are each related to different subject-matter areas, such as computer repair (A) and vehicle repair (B), the fact that the second domain D2 has correspondence with multiple diverse Qspaces is an indication that content at domain D2 is spread across a diverse range of subject-matter areas. Conversely, the fact that the first domain D1 has correspondence with only a single Qspace is an indication that content at domain D1 is specialized in very few (e.g., one) subject-matter areas.

In a sixth operation 406 of the method 400 illustrated in FIG. 2, the one or more processors generate, for each of the one or more domains, a score based at least in part on (i) a magnitude of the second prior search results from the domain and (ii) the correspondence between the domain and the search query categories associated with the subset of prior search queries. For example, the one or more processors 122 of the search computing system 120 may generate the score based on representations of first and second parameters.

The first parameter may be the total number of times prior search results from the domain appear in the second prior search results described above. Put another way, the first parameter may be the total number of times prior search results from the domain appear in search results which were returned in response to the subset of prior search queries mentioned previously with respect to the third operation 403. The first parameter represents the magnitude of second prior search results of the domain. In particular, the first parameter represents the volume and average frequency at which search results of the domain were returned.

The second parameter may be the total number of Qspaces associated with prior search queries in the subset of prior search queries which, when submitted to the search computing system 120 during the known time period, caused the search computing system 120 to return search results from the domain. This may be referred to as the total number of Qspaces with which the domain co-triggers. The second parameter represents the spread of search results from the domain across different Qspaces in the Total Qspace.

For example, the score for each domain may be generated as being directly proportional to a product of a representation of the first parameter and a log of an inverse representation of the second parameter. The following equation may be used,

$$TF - IDF = TF * Log ( c / DF )$$

where TF-IDF represents the score for the domain, TF represents the first parameter for the domain, and DF represents the second parameter for the domain. c may represent the total number of Qspaces. The score, TF-IDF, may be referred to as the ‘term frequency-inverse document frequency’ for the domain.

In a seventh operation 407 of the method 400 illustrated in FIG. 2, the one or more processors identify, from the one more domains, based at least in part on the score for each of the one or more domains, at least one domain from which to prioritize rendering of further search results at a user interface device in response to receipt by the computing system of a further search query. For example, the one or more processors 122 of the search computing system 120 may identify domains which scored highly in the sixth operation 406 as being candidates for prioritization when selecting search results to render at output devices 115 of the client device 110 in response to future search queries submitted from the client device 110. In doing so, the search computing system 120 may determine that, when responding to future search queries in Qspace A, domains which have strong correspondence with Qspace A and a user intent strongly associated with Qspace A should be prioritized for prominently rendered search results.

To give context, the one or more processors 122 of the search computing system 120 may determine that, when responding to a query in Qspace A related to computer maintenance, a domain which has been determined to have a specialized correspondence with Qspace A according to the fifth operation 405 and which is associated with a user intent strongly linked to Qspace A, such as a video intent, should be prioritized for returning search results for prominent rendering at the client device 110. Additionally or alternatively, the one or more processors 122 of the search computing system 120 may determine that, when responding to a query in Qspace B related to vehicle maintenance, a domain which has been determined to have a specialized correspondence with Qspace B according to the fifth operation 405 and which is associated with a user intent linked to Qspace B, such as an image intent, should be prioritized for returning search results for prominent rendering at the client device 110.

Additionally or alternatively, the one or more processors 122 of the search computing system 120 may determine that, when responding to a query in Qspace C related to wildlife sounds, a domain which has been determined to have a specialized correspondence with Qspace C according to the fifth operation 405 and which is associated with a user intent linked to Qspace C, such as an audio intent, should be prioritized for returning search results for prominent rendering at the client device 110. Additionally or alternatively, the one or more processors 122 of the search computing system 120 may determine that, when responding to a query in Qspace D related to trading bicycle parts, a domain which has been determined to have a specialized correspondence with Qspace D according to the fifth operation 405 and which is associated with a user intent linked to Qspace D, such as a commercial intent, should be prioritized for returning search results for prominent rendering at the client device 110. Additionally or alternatively, the one or more processors 122 of the search computing system 120 may determine that, when responding to a query in Qspace E related to home maintenance tasks, a domain which has been determined to have a specialized correspondence with Qspace E according to the fifth operation 405 and which is associated with a user intent linked to Qspace E, such a commercial intent derived from prior user selections of sponsored, or paid-for, search results, should be prioritized for returning search results for prominent rendering at the client device 110.

The method 400 may further comprise, in response to receipt by the computing system of the further search query, causing at least one further search result from the identified at least one domain to be rendered at the user interface device. As discussed above, the further search query may be associated with a particular search query category, i.e., a particular Qspace, and the at least one domain identified in the seventh operation 407 may have correspondence with the particular search query. As also discussed above, the first prior search results and the at least one further search result may each be associated with a content modality other than text, such as image content, video content, audio content, commerce content or sponsored content.

Causing the at least one further search result to be rendered at the user interface device may comprise causing the at least one further search result to be rendered with increased visual emphasis relative to one or more other rendered search results displayed alongside the at least one further search result at a display screen of the user interface device. Additionally or alternatively, this may comprise causing the at least one further search result to be rendered in a content-modality-specific portion of a user interface displayed at a display screen of the user interface device, such as under a specific tab or other selectable portion of the user interface.

For example, the further search result may be associated with image content and the content-modality-specific portion of the user interface may be a portion of the user interface which is specific to search results associated with image content. Alternatively, the further search result may be associated with video content and the content-modality-specific portion of the user interface may be a portion of the user interface specific to search results associated with video content.

Alternatively, the first prior search results may be associated with sponsored content, and causing the further search result to be rendered at the user interface device may comprise causing the further search result to be rendered as sponsored content.

Each of the first prior search results, the second prior search results and the at least one further search result may be indicative of web page content. For example, web page content may be provided by the web server computing apparatus(es) 300 discussed above with respect to FIG. 1.

Determining the correspondence between each of the one or more domains and search query categories (i.e., Qspaces) associated with the subset of prior search queries may comprise, for each prior search query in the subset of prior search queries, identifying the one or more domains as including domains of search results returned by the computing system in response to receipt of the prior search query, and determining, for each of the domains of search results returned by the computing system in response to receipt of the prior search query, a correspondence between the domain and the search query category associated with the prior search query.

As discussed above, generating the score for each of the one or more domains may comprise, for each prior search query in the subset of prior search queries, generating, for each of the domains of search results returned by the computing system (e.g., search computing system 120) in response to receipt of the prior search query, the score based at least in part on the determined correspondence between the domain and the one or more search query categories (i.e., Qspaces) associated with the prior search query. Generating the score may comprises multiplying (i) a representation of the magnitude of second prior search results from the domain, by (ii) an inverse representation of a magnitude of the search query categories corresponding to the domain.

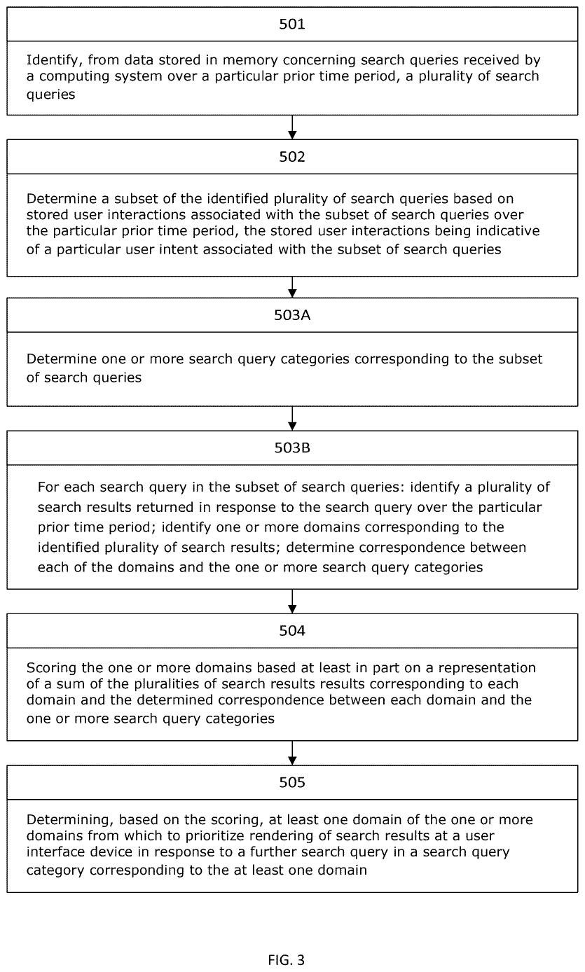

A further method which may be performed using the hardware and infrastructure discussed above in relation to FIG. 1 will now be described with respect to FIG. 3.

In a first operation 501 of the method 500 illustrated in FIG. 3, one or more processors identify, from data stored in memory concerning search queries received by a computing system over a particular prior time period, a plurality of search queries. For example, the one or more processors 122 of the search computing system 120 may identify from historical data stored in memory 121 of the computing system 120 a total of all prior search queries (or a subset plurality of those prior queries) submitted to the search computing system 120 from user devices over a certain prior timeframe. The user devices may be client devices 110 communicatively coupled to the search computing system 120 by the communication network(s) 200 discussed above. The prior time period may be any prior period which is representative of a large number of users submitting search queries to the system 120.

In a second operation 502 of the method 500 illustrated in FIG. 3, the one or more processors determine, from the data stored in memory, a subset of the identified plurality of search queries based on stored user interactions associated with the subset of search queries over the particular prior time period, wherein the stored user interactions are indicative of a particular user intent associated with the subset of search queries. For example, the one or more processors 122 of the search computing system 120 may determine, from the stored historical data, a Qspace of each of the prior search queries (or a significantly sized subset of those queries) submitted to the search computing system 120 over the prior time period.

The one or more processors 122 may determine, for example, that a first prior search query of “watches to wear while running” is of a first Qspace R related to fitness/health tracking wearables, and that a second prior search query of “connect my door camera” is of a second Qspace S related to smart home installations, and so on. The one or more processors may additionally identify all queries which, according to the historical data, led to user interactions indicative of particular user intents. This may involve, for example, identifying all queries which led to selections of image results. Additionally or alternatively, this may involve identifying all queries which led to selections of video results. Additionally or alternatively, this may involve identifying all queries which led to selections of audio results. Additionally or alternatively, this may involve identifying all queries which led to selections of commerce results. Additionally or alternatively, this may involve identifying all queries which led to selections of sponsored results.

Different user interactions may be indicative of different user intents associated with the search queries. For example, selection of a video result may be indicative of a video intent associated with the query, selection of an image result may be indicative of an image intent associated with the query, selection of an audio result may be indicative of an audio intent associated with the query, and selection of a commerce result may be indicative of a commercial intent associated with the query. Selection of a sponsored result may also be indicative of a commercial intent associated with the query.

When the historical data indicates that there was a disproportionally high number of prior search queries, all from a particular Qspace, that led to a user interaction with a particular type of search result, the Qspace as a whole may be determined as being associated with a user intent linked to the particular type of search result. A fraction may be used to assess this, such as the total number of ‘video’, ‘image’, ‘audio’, ‘commercial’ or ‘sponsored content’ interactions for the Qspace, as compared to the total interactions for the Qspace.

To give context, the one or more processors 122 may identify, for example, that prior search queries from Qspace R related to fitness/health tracking wearables led to a high number of user interactions with commerce-type search results. The one or more processors 122 may additionally or alternatively identify, for example, that prior search queries from Qspace S related to smart home installations led to a high number of user interactions with sponsored-type search results. The one or more processors 122 may determine from this that Qspaces R and S are both associated with a commercial intent, such as an intent to purchase a product or service.

The one or more processors 122 may then rank all of the Qspaces associated with the prior search queries to identify Qspaces which are highly (e.g., disproportionally) associated with particular intents, such as a commercial intent. Other intents are equally possible.

Where ranking of Qspaces is deployed, the prior search queries which are most associated with particular user intents are taken forward in the process (e.g., as the subset of prior search queries referred to above). All other prior search queries may be dismissed at this stage, on the basis that they may be regarded as not strongly-enough associated with a particular user intent.

In a third operation 503A of the method 500 illustrated in FIG. 3, the one or more processors determine one or more search query categories corresponding to the subset of search queries. The one or more processors also, in a second stage of the third operation 503B, for each search query in the subset of search queries, (i) identify a plurality of search results returned in response to the search query over the particular prior time period, (ii) identify one or more domains corresponding to the identified plurality of search results, and (iii) determine a correspondence between each of the identified one or more domains and the determined one or more search query categories.

This may involve the one or more processors 122 of the search computing system 120 determining Qspaces of each of the subset of search queries discussed above and identifying, from the stored historical data, for each of these Qspaces, all search results that were returned by the search computing system 120 for queries submitted in that Qspace. These results may then be aggregated at domain level, so that a correspondence between each domain and the different Qspaces can be determined across all of the subset of search queries. As discussed previously, domains which correspond to relatively high numbers of Qspaces are likely to be domains at which diverse content is spread across many subject-matter areas. On the hand, domains which correspond to relatively few Qspaces are likely to be domains at which the content is specialized to relatively few subject-matter areas.

In a fourth operation 504 of the method 500 illustrated in FIG. 3, the one or more processors score the one or more domains based at least in part on a representation of a sum of the pluralities of search results corresponding to each domain and the determined correspondence between each domain and the one or more search query categories.

For example, the one or more processors 122 of the search computing system 120 may generate the score based on representations of first and second parameters. The first parameter may be the total number of times prior search results from the domain appear in the prior search results returned in response to the subset of queries. The first parameter represents the magnitude of prior search results of the domain. In particular, the first parameter represents the volume and average frequency at which search results of the domain were returned.

The second parameter may be the total number of Qspaces associated with prior search queries in the subset of prior search queries which, when submitted to the search computing system 120 during the known time period, caused the search computing system 120 to return search results from the domain. This may be referred to as the total number of Qspaces with which the domain co-triggers. The second parameter represents the spread of search results from the domain across different Qspaces in the Total Qspace.

For example, the score for each domain may be generated as being proportional to a product of a representation of the first parameter and a log of an inverse representation of the second parameter. The following equation may be used,

$$TF - IDF = TF * Log ( c / DF )$$

where TF-IDF represents the score for the domain, TF represents the first parameter for the domain, and DF represents the second parameter for the domain. c may represent the total number of Qspaces. The score, TF-IDF, may be referred to as the ‘term frequency-inverse document frequency’ for the domain.

In a fifth operation 505 of the method 500 illustrated in FIG. 3, the one or more processors determine, based on the scoring, at least one domain of the one or more domains from which to prioritize rendering of search results at a user interface device in response to a further search query in a search query category corresponding to the at least one domain.

For example, the one or more processors 122 of the search computing system 120 may identify domains which scored highly in the fourth operation 504 as being candidates for prioritization when selecting search results to render at output devices 115 of the client device 110 in response to future search queries submitted from the client device 110. In doing so, the search computing system 120 may determine that, when responding to future search queries in Qspace R, domains which have strong correspondence with Qspace R and a user intent strongly associated with Qspace R should be prioritized for prominently rendered search results.

To give context, the one or more processors 122 of the search computing system 120 may determine that, when responding to a query in Qspace R related to fitness/health tracking wearables, a domain which has been determined to have a specialized correspondence with Qspace R according to the third operation 503 and which is associated with a user intent strongly linked to Qspace R, such as a commercial intent, should be prioritized for returning search results for prominent rendering at the client device 110. Additionally or alternatively, the one or more processors 122 of the search computing system 120 may determine that, when responding to a query in Qspace S related to smart home installations, a domain which has been determined to have a specialized correspondence with Qspace S according to the third operation 503 and which is associated with a user intent linked to Qspace S, such as a commercial intent, should be prioritized for returning search results for prominent rendering at the client device 110.

While the above-described examples have generally been described in the context of operations carried out by search computing system 120, the operations could alternatively be carried out in another computing apparatus with access to the stored historical data. The stored historical data may not necessarily be stored in, or accessed from, memory 121 of the search computing system 120, and may instead be stored in, or accessed from, memory of another computing apparatus.

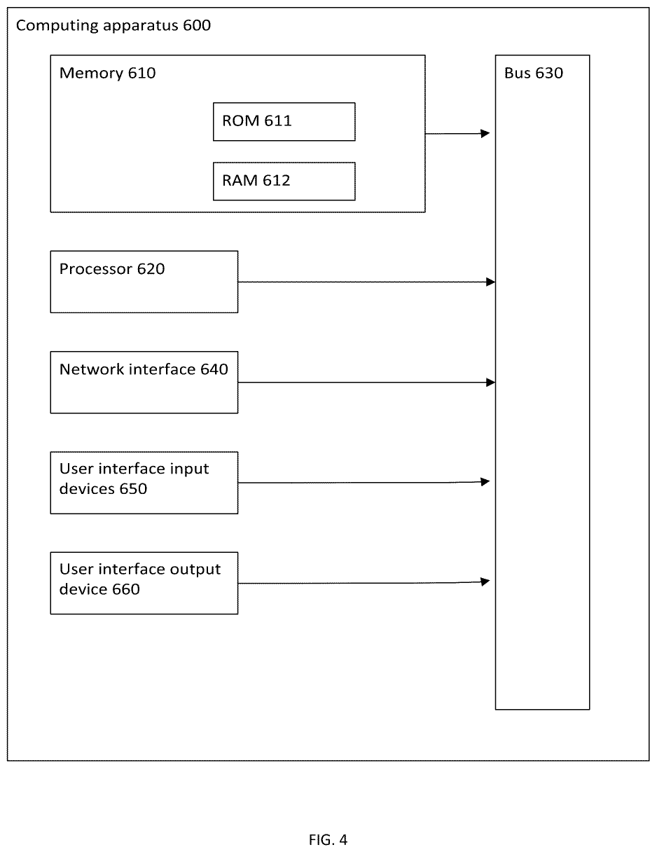

Referring to FIG. 4, computer apparatuses 600 implementing the methods described herein comprise memory 610 which stores programming and data constructs that provide the functionality described herein. For example, such memory 610 may include the logic to perform selected aspects of the methods disclosed herein, as well as to implement various components depicted and described with respect to FIG. 1. These software modules are generally executed by a processor 620 alone or in combination with other processors. There may be a number of memories including a main random access memory (RAM) 611 for storage of instructions and data during program execution and a read only memory (ROM) 612 in which fixed instructions are stored. A file storage subsystem 613 can provide persistent storage for program and data files, and may include a hard disk drive, a floppy disk drive along with associated removable media, a CD-ROM drive, an optical drive, or removable media cartridges. The modules implementing the functionality may be stored by a file storage subsystem, or in other machines accessible by the processor(s) 620.

A bus subsystem 630 may provide a mechanism for facilitating communication between the various components and subsystems. Although bus subsystem 630 is shown as a single bus, there may in fact be multiple busses. The computing apparatus 600 may be of varying types including a workstation, server, computing cluster, blade server, server farm, or any other data processing system or computing device. Many other configurations of computing apparatus 600 are possible, having more or fewer components than the computing apparatus 600 shown in FIG. 4.

Implementations of the computing apparatus 600 may include one or more processors (e.g., central processing unit(s) (CPU(s)), graphics processing unit(s) (GPU(s), and/or tensor processing unit(s) (TPU(s)), where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product, and/or computer program, including instructions executable by one or more processors to perform any of the aforementioned methods.

1. A method implemented by one or more processors, the method comprising:
identifying, from data stored in at least one memory, a plurality of prior search queries received by a computing system over a particular prior time period;
determining, for each of the prior search queries, from a plurality of search query categories, a search query category associated with the prior search query;
identifying a subset of the prior search queries based at least in part on stored user interactions with first prior search results returned, by the computing system, in response to receipt of the subset of prior search queries over the particular prior time period;
identifying one or more domains that comprise one or more web resource domains of second prior search results returned, by the computing system, in response to receipt of the subset of prior search queries over the particular prior time period;
determining a correspondence between each of the one or more domains and search query categories associated with the subset of prior search queries;
generating, for each of the one or more domains, a score to down-weight any of the one or more domains that is diverse across many query categories based at least in part on (i) a magnitude of the second prior search results from the domain and (ii) an inverse of the correspondence between the domain and the search query categories associated with the subset of prior search queries;
identifying, from the one more domains, based at least in part on the score for each of the one or more domains, at least one domain from which to prioritize rendering of further search results at a user interface device in response to receipt by the computing system of a further search query.

2. The method of claim 1, wherein the stored user interactions with the first prior search results are representative of particular user intents associated with the subset of prior search queries.

3. The method of claim 1, further comprising, in response to receipt by the computing system of the further search query, causing at least one further search result from the identified at least one domain to be rendered at the user interface device.

4. The method of claim 3, wherein the further search query is associated with a particular search query category and the identified at least one domain has correspondence with the particular search query.

5. The method of claim 3, wherein the first prior search results and the at least one further search result are each associated with a content modality other than text.

6. The method of claim 5, wherein the content modality is image content or video content.

7. The method of claim 3, wherein causing the at least one further search result to be rendered at the user interface device comprises:
causing the at least one further search result to be rendered with increased visual emphasis relative to one or more other rendered search results displayed alongside the at least one further search result at a display screen of the user interface device.

8. The method of claim 3, wherein causing the at least one further search result to be rendered at the user interface device comprises:
causing the at least one further search result to be rendered in a content-modality-specific portion of a user interface displayed at a display screen of the user interface device.

9. The method of claim 8, wherein the at least one further search result is associated with image content and the content-modality-specific portion of the user interface is a portion of the user interface specific to search results associated with image content or video content.

10. (canceled)

11. The method of claim 1, wherein the first prior search results are associated with sponsored content,
further comprising:
causing, in response to receipt by the computing system of the further search query, the at least one further search result to be rendered as sponsored content.

12. The method of claim 1, wherein each of the first prior search results, the second prior search results and at least one further search result are indicative of web page content.

13. The method of claim 1, wherein determining the correspondence between each of the one or more domains and search query categories associated with the subset of prior search queries comprises:
for each prior search query in the subset of prior search queries:
identifying the one or more domains as including domains of search results returned by the computing system in response to receipt of the prior search query; and
determining, for each of the domains of search results returned by the computing system in response to receipt of the prior search query, a correspondence between the domain and the search query category associated with the prior search query.

14. The method of claim 13, wherein generating a score for each of the one or more domains comprises:
for each prior search query in the subset of prior search queries:
generating, for each of the domains of search results returned by the computing system in response to receipt of the prior search query, the score based at least in part on the determined correspondence between the domain and one or more of the search query categories associated with the prior search query.

15. The method of claim 1, wherein generating a score for each of the one or more domains comprises multiplying:
(i) a representation of the magnitude of second prior search results from the domain, by
(ii) an inverse representation of a magnitude of the search query categories corresponding to the domain.

16. A method implemented by one or more processors, the method comprising:
identifying, from data stored in memory concerning search queries received by a computing system over a particular prior time period, a plurality of search queries;
determining, from the data stored in memory, a subset of the identified plurality of search queries based on stored user interactions associated with the subset of search queries over the particular prior time period, wherein the stored user interactions are indicative of a particular user intent associated with the subset of search queries;
determining one or more search query categories corresponding to the subset of search queries;
for each search query in the subset of search queries:
identifying a plurality of search results returned in response to the search query over the particular prior time period;
identifying one or more domains that comprise one or more web resource domains corresponding to the identified plurality of search results; and
determining an inverse of a correspondence between each of the identified
one or more domains and the determined one or more search query categories;
scoring the one or more domains based at least in part on a representation of a sum of the pluralities of search results corresponding to each domain and the determined inverse of the correspondence between each domain and the one or more search query categories; and
determining, based on the scoring, at least one domain of the one or more domains from which to prioritize rendering of search results at a user interface device in response to a further search query in a search query category corresponding to the at least one domain.

17. The method of claim 16, further comprising, in response to receipt by the computing system of the further search query, causing at least one further search result from the determined at least one domain to be rendered in a prominent region of a user interface displayed at a display screen of the user interface device.

18. (canceled)

19. A system comprising:
one or more processors; and
at least one memory storing instructions which, when executed by the one or more processors, cause the one or more processors to:
identify a plurality of prior search queries received by a computing system over a particular prior time period;
determine, for each of the prior search queries, from a plurality of search query categories, a search query category associated with the prior search query;
identify a subset of the prior search queries based at least in part on stored user interactions with first prior search results returned, by the computing system, in response to receipt of the subset of prior search queries over the particular prior time period;
identify one or more domains that comprise one or more web resource domains of second prior search results returned, by the computing system, in response to receipt of the subset of prior search queries over the particular prior time period;
determine an inverse of a correspondence between each of the one or more domains and search query categories associated with the subset of prior search queries;
generate, for each of the one or more domains, a score based at least in part on (i) a magnitude of the second prior search results from the domain and (ii) the inverse of the correspondence between the domain and the search query categories associated with the subset of prior search queries;
identify, from the one more domains, based at least in part on the score for each of the one or more domains, at least one domain from which to prioritize rendering of further search results at a user interface device in response to receipt by the computing system of a further search query.

20. A non-transitory computer-readable storage medium storing instructions which, when executed by one or more processors, cause the one or more processors to be operable to:
identify a plurality of prior search queries received by a computing system over a particular prior time period;
determine, for each of the prior search queries, from a plurality of search query categories, a search query category associated with the prior search query;
identify a subset of the prior search queries based at least in part on stored user interactions with first prior search results returned, by the computing system, in response to receipt of the subset of prior search queries over the particular prior time period;
identify one or more domains that comprise one or more web resource domains of second prior search results returned, by the computing system, in response to receipt of the subset of prior search queries over the particular prior time period;
determine an inverse of a correspondence between each of the one or more domains and search query categories associated with the subset of prior search queries;
generate, for each of the one or more domains, a score based at least in part on (i) a magnitude of the second prior search results from the domain and (ii) the inverse of the correspondence between the domain and the search query categories associated with the subset of prior search queries; and
identify, from the one more domains, based at least in part on the score for each of the one or more domains, at least one domain from which to prioritize rendering of further search results at a user interface device in response to receipt by the computing system of a further search query.

21. The method of claim 1, wherein generating, for each of the one or more domains, the score comprises generating, for each of the one or more domains, the score using a term frequency-inverse domain frequency (TF-IDF) calculation based at least in part on (i) a term frequency (TF) metric identified from the magnitude of the second prior search results from the domain and (ii) an inverse domain frequency (IDF) metric identified from the inverse of the correspondence between the domain and the search query categories associated with the subset of prior search queries.

22. The method of claim 1, wherein generating the score uses the inverse of the correspondence to quantitatively deemphasize any of the one or more domains that corresponds to more than a threshold number of search query categories.
